(19) United States
(12) Patent Application Publication
(10) Pub. No.: US 2006/0152935 A1
(43) Pub. Date: Jul. 13, 2006

(54) Interactive headlight control system

(76) Inventor: Roumen Petkov, Montreal (CA)

Correspondence Address: Roumen Petkov, 3540 Av du Parc #51, Montreal Quebec, H2X 2H7, CA

(21) Appl. No.: 10/522,267

(22) PCT Filed: Jul. 24, 2002
(86) PCT No.: PCT/CA02/01200

§ 371 Date: Aug. 11, 2005

(51) Int. Cl. B60Q 1/076

(52) U.S. Cl. 362/459; 340/438

(57) ABSTRACT

The present invention relates to an interactive headlight control system providing a vehicle on which it is installed means for remotely automatically controlling headlights of other surrounding vehicles by sending outgoing remote-action signals. More particularly, the headlight control system provides the vehicle on which it is installed the ability of automatically switching headlights of other surrounding vehicles by remote control from their high position to their low position, and to maintain their headlights in low position, even if they have manually been set to high position. The headlight control system also provides means for receiving and reacting to such signals.

### FIELD OF THE INVENTION

The present invention relates to an electronic system destined to be installed on a road vehicle for automatically sending a remote signal to other surrounding vehicles for controlling the intensity of their headlights.

### BACKGROUND OF THE INVENTION

When motorists drive with their headlights on a highway or other road having elongated straight or substantially straight sections, they are prone to sustain a glare from other motorists' headlights, either incoming forwardly in the opposite direction or incoming behind them in the same direction to pass laterally at higher speeds. Such a glare can have hazardous effects, i.e. be blinding to the motorist, when the headlights of these incoming cars are not manually shifted by their driver from the so-called “high” position, which is effective for example where highway lamp posts are absent or sparsely settled, to the “low” position, where the headlights are downwardly directed so as to substantially decrease this glare to other motorists. Usually, careful motorists will manually shift their headlights into low position and later shift their headlights back into high position whenever they see through their windshield a car incoming forwardly, or when they see through their rear-view mirror an incoming car behind them coming to pass at greater speed.

The problem with such a conventional system is that motorists often forget to manually shift their headlights into low position when incoming motorists are in sight, so that they maintain their headlights constantly at the high position. Clearly, such a situation is hazardous for both drivers, because the glare of the headlights in high position can become incapacitating to the driver and “blind” him for some period of time, typically at least a few seconds.

Accidents may occur as a result of the vehicle drivers being temporarily blinded in such a way.

### SUMMARY OF THE INVENTION

The present invention relates to an interactive headlight control system, for use on a motorized vehicle comprising front headlights capable of switching between a high and a low position and a headlight circuitry capable of selectively switching the headlights between their high and low positions; said headlight control system comprising:
an electronic circuit;
at least one light sensor destined to be oriented outwardly of the vehicle, said light sensor operatively communicating with said electronic circuit, said light sensor sensitive to lumen value from vehicle headlights;
at least one electromagnetic receiver capable of receiving external incoming proximity signals, and of communicating with said electronic circuit;
at least one electromagnetic transmitter for transmitting outgoing proximity signals, said transmitter controlled by said electronic circuit;
   wherein upon said electromagnetic receiver receiving a detectable proximity signal, said electronic circuit will issue a command controlling the headlight circuitry for switching and maintaining the headlights in their low position, and wherein upon said light sensor sensing a light intensity at least equal to a determined threshold value of light intensity, said electronic circuit will control said electromagnetic transmitter for transmitting a proximity signal.

In one embodiment, said electronic circuit comprises a central processing unit (CPU).

The present invention also relates to, a motorized vehicle comprising a front headlight system capable of switching between a high position and a low position and a headlight circuitry capable of selectively switching said headlight system between said high position and said low position, said motorized vehicle also comprising a headlight control system comprising:
an electronic circuit;
at least one light sensor destined to be oriented outwardly of the vehicle, said light sensor capable of communicating with said electronic circuit, said light sensor sensitive to lumen value from vehicle headlights;
at least one electromagnetic receiver capable of receiving external incoming proximity signals, and of communicating with said electronic circuit;
at least one electromagnetic transmitter for transmitting outgoing proximity signals, said transmitter controlled by said electronic circuit;
   wherein upon said electromagnetic receiver receiving a detectable proximity signal, said electronic circuit will issue a command controlling said headlight circuitry and switching and maintaining the headlights in their low position, and wherein upon said light sensor sensing a light intensity at least equal to a minimal threshold value of light intensity, said electronic circuit will control said electromagnetic transmitter for transmitting a proximity signal.

In one embodiment, said emitter, transmitter and sensor of said headlight control system form a first integrated electromagnetic unit.

In one embodiment, further comprising a second electromagnetic unit, and wherein said first electromagnetic unit is located in front of said vehicle, said transmitter, said receiver, said light sensor of said first electromagnetic unit oriented forwardly, and said second electromagnetic unit located at the rear of said vehicle; said second electromagnetic unit comprising three rearwardly oriented elements: a second transmitter, a second receiver and a second light sensor.

In one embodiment, the motorized vehicle further comprises a nighttime detector sensitive to lumen value from ambient light, said nighttime detector being operatively connected to said electronic circuit, said electronic circuit de-activating said headlight control system upon the ambient light intensity increasing beyond said minimal threshold of ambient light intensity.

The present invention also relates to an interactive headlight control system, for use on a motorized vehicle of the type comprising front headlights capable of switching between a high and a low position and a headlight circuitry capable of selectively switching the headlights between their high and low positions;

said headlight control system comprising:

an electronic circuit;
at least one light sensor destined to be oriented outwardly of the vehicle, said light sensor capable of sensing the amount of light directed towards it;
receiver means for receiving external incoming proximity signals;
transmitter means for transmitting outgoing proximity signals, said transmitting means commanded by said electronic circuit;
communication means connecting said light sensor, said receiver means and said transmitter means to said electronic circuit;
   wherein upon said receiver means receiving a detectable proximity signal, said electronic circuit will issue a command controlling the headlight circuitry for switching and maintaining the headlights in their low position, and wherein upon said light sensor sensing a light intensity at least equal to a determined threshold value of light intensity, said electronic circuit will control said transmitter means for transmitting a proximity signal.

### DESCRIPTION OF THE DRAWINGS

In the annexed drawings:

FIG. 1 is a schematic side elevational view of a car equipped with an interactive headlight control system;

FIG. 2 is a schematic view of the interactive headlight control system suggesting the interaction between the main components of the system and the vehicle on which it is destined to be installed;

FIG. 3 is a schematic top plan view of a car equipped with an interactive headlight control system, showing a fan-shaped proximity signal being transmitted from an electromagnetic transmitter located in a front electromagnetic box;

FIG. 4 shows a schematic top plan view of two vehicles in motion on a two-way road and equipped with an interactive headlight control system of the invention, the directions on the road being suggested by solid-filled arrows;

FIG. 5 on the first sheet of drawings shows a schematic perspective view of an electromagnetic box circumscribed in circle 5 of FIG. 1; and

FIG. 6 shows a schematic perspective view of an electromagnetic box circumscribed in circle 6 of FIG. 1.

### DETAILED DESCRIPTION OF THE EMBODIMENTS

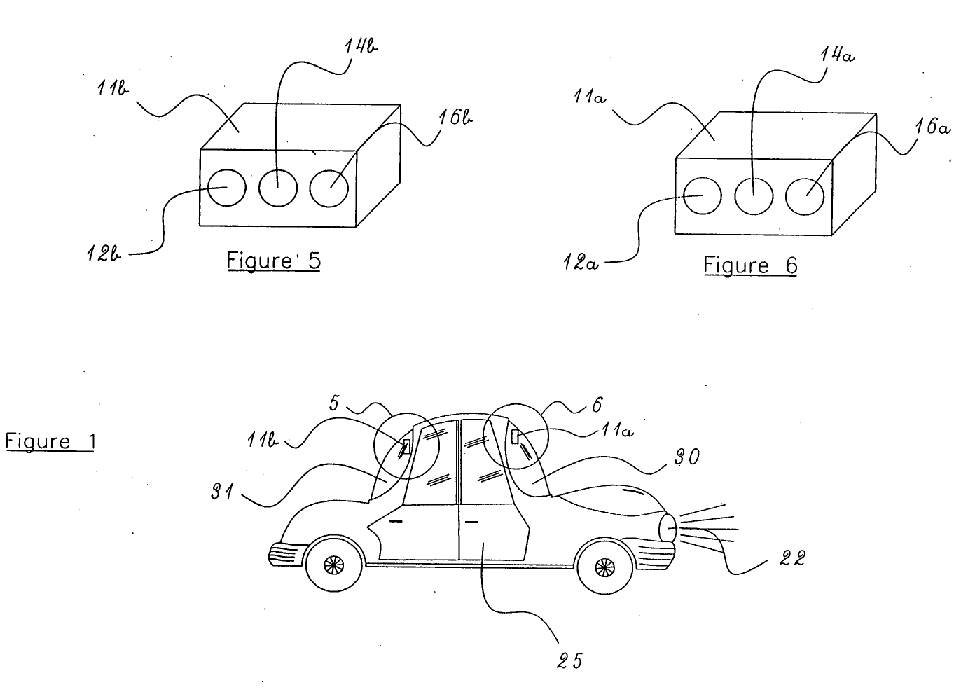

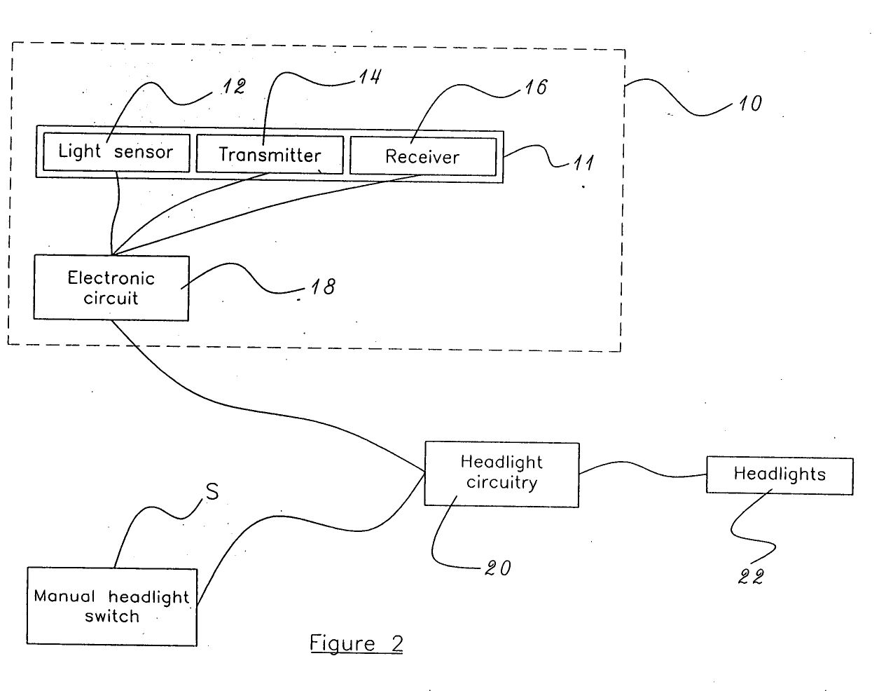

As suggested in FIGS. 1-2 of the drawings, the interactive headlight control system 10 of the invention, also referred to as apparatus 10 in the following specification, provides a vehicle on which it is destined to be installed means for automatically and remotely controlling headlights, marked as 22 in the drawings, of other surrounding vehicles by sending outgoing remote-action signals. Headlight control system 10 also provides means for receiving and reacting to such signals.

More particularly, apparatus 10 provides the vehicle on which it is installed the ability of automatically switching headlights 22 of other surrounding vehicles from their high position to their low position, and to maintain their headlights 22 in low position, even if they have manually been set to high position. Headlights 22 are set usually in “high” position for improved night vision where highway lamp posts are absent or sparsely settled, and are likely to briefly incapacitate the motorist(s) towards whom the headlight beams are directed. The “low” position is a headlight position wherein headlights 22 are downwardly directed so as to substantially decrease the glare sustained by other surrounding motorists. Headlights 22 in high position project high beams, and headlights 22 in low position project low beams, as known in the art. Other headlight systems include a first pair of headlights for low beams, and a second pair of headlights for high beams.

The above-mentioned remote-action signals are for example electromagnetic (EM) signals. An EM signal is defined as follows: it is an airborne signal, such as a radio signal, a magnetic signal, an infrared signal, or any other suitable type of airborne signal. An EM signal is an information-carrying signal. Hence, an EM receiver is capable of receiving these so-called EM signals, and an EM transmitter is capable of generating and transmitting such signals.

Now referring to FIG. 2, apparatus 10 comprises: an electromagnetic box (EMB) 11 and an electronic circuit 18.

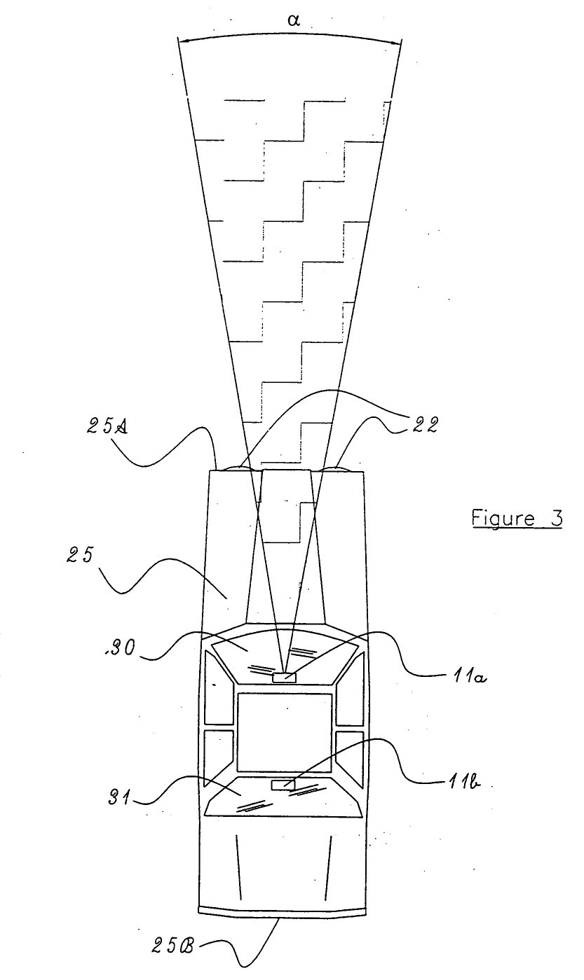

EMB 11 comprises: a light sensor 12, an EM transmitter 14, and an EM receiver 16. As shown in FIGS. 3,4, transmitter 14 is of the type being able to transmit a fan-shaped outgoing EM signal towards a chosen direction. In one embodiment, the fan-shaped signal is emitted according to a divergent angle α having a 15 to 25 degree value, as shown in FIG. 3. In FIG. 3, the open-based cone hatched with step-shaped lines schematically represents the transmitted EM signal. Light sensor 12 is able to sense the amount of light directed towards it. EM receiver 16 is able to receive incoming EM signals.

Electronic circuit 18 is connected to light sensor 12, transmitter 14 and receiver 16. In one embodiment, the connection is made with conventional electric wiring. Alternative embodiments could exist wherein light sensor 12, transmitter 14 and receiver 16 would exchange data with electronic circuit 18 through a radio link, or any other kind of EM communication protocol.

Electronic circuit 18 controls headlights 22 of the vehicle on which it is installed, accordingly to the incoming EM signals received by receiver 16. According to the amount of light directed towards light sensor 12, electronic circuit 18 will decide if an EM signal should be sent for switching headlights 22 of the surrounding vehicles having an apparatus 10 located therein into low position.

Electronic circuit 18 can for example be located next to the on-board computer of the vehicle. In one embodiment wherein apparatus 10 is built-in on a vehicle instead of being installed on a vehicle initially unequipped with an apparatus 10, the on-board computer of the vehicle could integrate the functions of electronic circuit 18.

Apparatus 10 is destined to be used on a road vehicle. For the purpose of the present specification, we will proceed with the description using a car 25 as the vehicle having an apparatus 10 installed therein. Nonetheless, it is understood that apparatus 10 can also be used on a truck, a motorcycle, or any other motorized road vehicle.

Car 25 defines a front portion 25A and a rear portion 25B, the front portion 25A being the portion where headlights 22 and a windshield 30 are located, and the rear portion 25B being the opposite portion of car 25, where the muffler and rear window 31 are located.

Headlights 22 of car 25 are controlled by a headlight circuitry, marked as 20 in FIG. 2. When a motorist manually wants to set his car's headlights 22 in high position, by activating a switch S located on the control panel of car 25 for example, headlights 22 will be switched into high position through the instrumentality of headlight circuitry 20. Headlight circuitry 20 can be embedded within the car's on-board computer, or can be any form of headlight controlling unit as known in the art.

In one embodiment, as illustrated in FIGS. 1 and 3, car 25 can be equipped with two EMB 11, namely a front EMB 11a and a rear EMB 11b. The components located in the front EMB 11a will be referenced to by their generic number, followed by the letter ‘a’ (i.e. light sensor 12a being the front light sensor). The components located in the rear EMB 11b will be referenced to by their generic number, followed by the letter ‘b’ (i.e. light sensor 12b being the rear light sensor). EMB 11a is installed in front and inside of car 25, for example adjacent to windshield 30, around the rear view mirror. EMB 11a is destined to interact with other vehicles also equipped with an apparatus 10, located forwardly relatively to car 25. EMB 11b is installed at the back and inside of car 25, for example around the top middle area of rear window 31. EMB 11b is destined to interact with vehicles equipped with an apparatus 10 and located rearwardly. EMB 11a and 11b are mounted inside the car cockpit and are oppositely oriented, light sensors 12a, 12b, transmitters 14a, 14b and receivers 16a, 16b having a line of sight outwardly directed and crossing respectively windshield 30 and rear window 31.

Light sensor 12a can hence sense forwardly incoming light beams, transmitter 14a can transmit forwardly outgoing EM signals, and receiver 16a can receive forwardly incoming EM signals. Light sensor 12b, transmitter 14b, and receiver 16b work similarly, but in the opposite direction.

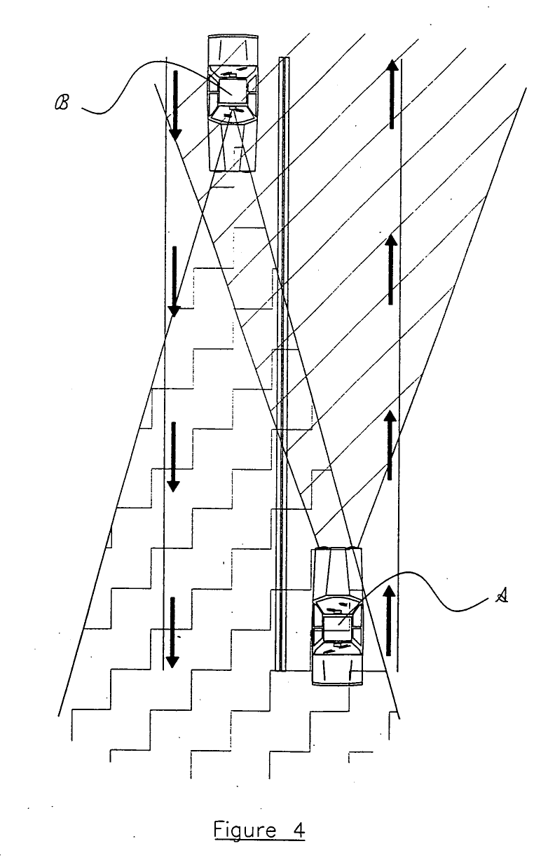

Now referring to FIG. 4, if a vehicle A equipped with an apparatus 10 has its headlights 22 active, and approaches another vehicle B equipped with an apparatus 10, the two vehicles being positioned in order for the conical beam of headlights 22 of vehicle A to intercept vehicle B, light sensor 12 of apparatus 10 installed on vehicle B will sense headlight beams incoming from headlights 22 of vehicle A. The headlight beams projected by vehicle A are represented in FIG. 4 by an open-based cone hatched with straight lines. Electronic circuit 18 would then command EM transmitter 14 to transmit a proximity signal. A proximity signal is an EM signal, and is sent to notify vehicles located within the range of the signal that their headlights 22 have to be switched or maintained in low position, and is represented in FIG. 4 by an open-based cone hatched with step-shaped lines. If vehicle B is equipped with two EMB 11a and 11b as mentioned hereinabove, then the proximity signal is sent only from transmitter 14 located in the same EMB 11 as light sensor 12 having sensed beams incoming from the headlights 22 of vehicle A. For example, if front light sensor 12a senses headlight beams, then only front transmitter 14a will transmit a proximity signal. All vehicles equipped with an apparatus 10, located within the intercept range of the fan-shaped proximity signal and having their headlights 22 in high position, receive the transmitted incoming proximity signal. If their headlights 22 are in high position when they receive the proximity signal, their electronic circuit 18 commands the headlight circuitry 20 to switch headlights 22 to low position, and to maintain them in this position as long as they keep receiving an incoming proximity signal.

When vehicle A stops receiving an incoming proximity signal, because receiver 16 of vehicle A goes out of range of the proximity signal transmitted by vehicle B, or because vehicle B stops transmitting the proximity signal, headlights 22 of vehicle A are set back to their high position, if the motorist hasn't manually switched headlights 22 of vehicle A off or back to their low position.

Hence, when a given vehicle A comes across another given vehicle B, either incoming forwardly in the opposite direction or incoming behind it in the same direction to pass laterally at greater speed, apparatus 10 prevents that the motorist aboard vehicle A sustains a glare from high beams incoming from headlights 22 of vehicle B, or vice-versa. Such a glare can have hazardous effects, i.e. be incapacitating to the motorist, if headlights 22 of these incoming cars are not manually shifted by their driver from high position to low position.

Light sensor 12 is operatively connected to electronic circuit 18. Upon light sensor 12 sensing at least a predetermined minimum threshold of light intensity corresponding to the intensity of low beams directed towards car 25, electronic circuit 18 will command EM transmitter 16 to transmit a proximity signal. The transmitted proximity signal does not target a specific vehicle. As mentioned hereinabove, it is a fan-shaped proximity signal having a 15 to 20 degree angular spread and a range limited by line of sight obstacles and it is received by all vehicles equipped with an apparatus 10 and located within its range.

If a vehicle having its headlights 22 set in high position receives this signal through receiver 16, electronic circuit 18 will command headlight circuitry 20 to switch headlights 22 of the vehicle into low position, and will subsequently maintain headlights 22 in their low position, unless the motorist driving the vehicle manually shuts off the headlights of his vehicle, in which case the manual controls of the car overrides the control of apparatus 10. If a motorist's car's headlights 22 are powered-off or are set into low position, and receiver 16 of the same car is receiving a proximity signal, and the motorist tries to manually switch his headlights to high position, by activating the switch S located on the control panel of car C for example, apparatus 10 will prevent access to and block the intensity switch of headlights 22 until receiver 16 stops receiving a proximity signal.

In one embodiment, car 25 further comprises a “nighttime detector”, capable of sensing the amount of ambient light. Such a device already exists in prior art, and is commonly used for controlling the intensity of the headlights of the vehicle on which it is installed, according to the sensed amount of ambient light. In this embodiment, apparatus 10 is idle unless the amount of sensed ambient light is below a predetermined minimum threshold value. Consequently, if enough ambient light is sensed, i.e. there is enough ambient light for the motorist to drive his vehicle without needing complementary lighting from his vehicle's headlights 22, the control of headlights 22 is manually controlled by the motorist. If the amount of ambient light sensed by nighttime detector is below the above-mentioned predetermined minimum threshold value, apparatus 10 enters its operative state, and the control of the headlights is shunt from the manual controls to the headlight control system 10.

In an alternative embodiment, electronic circuit 18 can comprise an independent CPU used exclusively for processing data issued from or needed by the different components of apparatus 10.

For the present invention to become operational, it is understood that it must become a standard car component. It needs to equip not only new cars sold on the market, but also to be retrofitted to all existing cars as a condition for their upcoming yearly car registration renewal.

1. An interactive headlight control system, for use on a motorized vehicle comprising front headlights capable of switching between a high and a low position and a headlight circuitry capable of selectively switching the headlights between their high and low positions;
said headlight control system comprising:
an electronic circuit;
at least one light sensor destined to be oriented outwardly of the vehicle, said light sensor operatively communicating with said electronic circuit, said light sensor sensitive to lumen value from vehicle headlights;
at least one electromagnetic receiver capable of receiving external incoming proximity signals, and of communicating with said electronic circuit;
at least one electromagnetic transmitter for transmitting outgoing proximity signals, said transmitter controlled by said electronic circuit;
wherein upon said electromagnetic receiver receiving a detectable proximity signal, said electronic circuit will issue a command controlling the headlight circuitry for switching and maintaining the headlights in their low position, and wherein upon said light sensor sensing a light intensity at least equal to a determined threshold value of light intensity, said electronic circuit will control said electromagnetic transmitter for transmitting a proximity signal.

2. The apparatus of claim 1, wherein said transmitter, said receiver, and said light sensor form an integrated unit.

3. The apparatus of claim 1, wherein said electronic circuit comprises a central processing unit (CPU).

4. A motorized vehicle comprising a front headlight system capable of switching between a high position and a low position and a headlight circuitry capable of selectively switching said headlight system between said high position and said low position, said motorized vehicle also comprising a headlight control system comprising:
an electronic circuit;
at least one light sensor destined to be oriented outwardly of the vehicle, said light sensor capable of communicating with said electronic circuit, said light sensor sensitive to lumen value from vehicle headlights;
at least one electromagnetic receiver capable of receiving external incoming proximity signals, and of communicating with said electronic circuit;
at least one electromagnetic transmitter for transmitting outgoing proximity signals, said transmitter controlled by said electronic circuit;
wherein upon said electromagnetic receiver receiving a detectable proximity signal, said electronic circuit will issue a command controlling said headlight circuitry and switching and maintaining the headlights in their low position, and wherein upon said light sensor sensing a light intensity at least equal to a minimal threshold value of light intensity, said electronic circuit will control said electromagnetic transmitter for transmitting a proximity signal.

5. The motorized vehicle of claim 4, wherein said emitter, transmitter and sensor of said headlight control system form a first integrated electromagnetic unit.

6. The motorized vehicle of claim 5, further comprising a second electromagnetic unit, and wherein said first electromagnetic unit is located in front of said vehicle, said transmitter, said receiver, said light sensor of said first electromagnetic unit oriented forwardly, and said second electromagnetic unit located at the rear of said vehicle; said second electromagnetic unit comprising three rearwardly oriented elements: a second transmitter, a second receiver and a second light sensor.

7. The motorized vehicle of claim 4, further comprising a nighttime detector sensitive to lumen value from ambient light, said nighttime detector being operatively connected to said electronic circuit, said electronic circuit de-activating said headlight control system upon the ambient light intensity increasing beyond said minimal threshold of ambient light intensity.

8. The apparatus of claim 4, wherein said electronic circuit comprises a central processing unit (CPU).

9. An interactive headlight control system, for use on a motorized vehicle of the type comprising front headlights capable of switching between a high and a low position and a headlight circuitry capable of selectively switching the headlights between their high and low positions;
said headlight control system comprising:
an electronic circuit;
at least one light sensor destined to be oriented outwardly of the vehicle, said light sensor capable of sensing the amount of light directed towards it;
receiver means for receiving external incoming proximity signals;
transmitter means for transmitting outgoing proximity signals, said transmitting means commanded by said electronic circuit;
communication means connecting said light sensor, said receiver means and said transmitter means to said electronic circuit;
wherein upon said receiver means receiving a detectable proximity signal, said electronic circuit will issue a command controlling the headlight circuitry for switching and maintaining the headlights in their low position, and wherein upon said light sensor sensing a light intensity at least equal to a determined threshold value of light intensity, said electronic circuit will control said transmitter means for transmitting a proximity signal.
